(19) United States
(12) Patent Application Publication
(10) Pub. No.: US 2011/0090423 A1
(43) Pub. Date: Apr. 21, 2011

(54) ILLUMINATION DEVICE WITH PROGRESSIVE INJECTION

(76) Inventors: John A. Wheatley, Lake Elmo, MN (US); Rolf W. Biernath, Wyoming, MN (US); Michael A. Meis, Stillwater, MN (US); David G. Freier, Saint Paul, MN (US); Tao Liu, Woodbury, MN (US); Timothy J. Nevitt, Red Wing, MN (US)

(21) Appl. No.: 12/997,269

(22) PCT Filed: May 11, 2009
(86) PCT No.: PCT/US09/43405

§ 371 Date: Dec. 10, 2010

Related U.S. Application Data
(60) Provisional application No. 61/061,230, filed on Jun. 13, 2008.

(51) Int. Cl. G02F 1/13357; F21V 7/00; G02F 1/1335

(52) U.S. Cl. 349/62; 362/235; 362/97.1

(57) ABSTRACT

Illumination devices having a partially transmissive front reflector, a back reflector, and a cavity between them are disclosed. At least one light injector including a baffle and a light source is disposed in the cavity. The light injector is capable of injecting partially collimated light into the cavity. The output area of the illumination device can be increased by disposing light injectors progressively within the cavity, without sacrificing uniformity of the light emitted through the output area.

### FIELD

The present disclosure relates to illumination devices suitable for illuminating a display or other graphic from behind, such as a backlight. The disclosure is particularly well suited, but not limited, to large area backlights that emit visible light of substantially one polarization state.

### BACKGROUND

Illumination devices such as backlights can be considered to fall into one of two categories depending on where the internal light sources are positioned relative to the output area of the backlight, where the backlight “output area” corresponds to the viewable area or region of the display device. The “output area” of a backlight is sometimes referred to herein as an “output region” or “output surface” to distinguish between the region or surface itself and the area (the numerical quantity having units of square meters, square millimeters, square inches, or the like) of that region or surface.

The first category is “edge-lit”. In an edge-lit backlight, one or more light sources are disposed—from a plan-view perspective—along an outer border or periphery of the backlight construction, generally outside the area or zone corresponding to the output area. Often, the light source(s) are shielded from view by a frame or bezel that borders the output area of the backlight. The light source(s) typically emit light into a component referred to as a “light guide”, particularly in cases where a very thin profile backlight is desired, as in laptop computer displays. The light guide is a clear, solid, and relatively thin plate whose length and width dimensions are on the order of the backlight output area. The light guide uses total internal reflection (TIR) to transport or guide light from the edge-mounted lamps across the entire length or width of the light guide to the opposite edge of the backlight, and a non-uniform pattern of localized extraction structures is provided on a surface of the light guide to redirect some of this guided light out of the light guide toward the output area of the backlight. Such backlights typically also include light management films, such as a reflective material disposed behind or below the light guide, and a reflective polarizing film and prismatic BEF film(s) disposed in front of or above the light guide, to increase on-axis brightness.

In the view of Applicants, drawbacks or limitations of existing edge-lit backlights include: the relatively large mass or weight associated with the light guide, particularly for larger backlight sizes; the need to use components that are non-interchangeable from one backlight to another, since light guides must be injection molded or otherwise fabricated for a specific backlight size and for a specific source configuration; the need to use components that require substantial spatial non-uniformities from one position in the backlight to another, as with existing extraction structure patterns; and, as backlight sizes increase, increased difficulty in providing adequate illumination due to limited space or “real estate” along the edge of the display, since the ratio of the perimeter to the area of a rectangle decreases linearly (l/L) with the characteristic in-plane dimension L (e.g., length, or width, or diagonal measure of the output region of the backlight, for a given aspect ratio rectangle). It is difficult to inject light into a solid light guide at any point other than the periphery, due to costly machining and polishing operations.

The second category is “direct-lit”. In a direct-lit backlight, one or more light sources are disposed—from a plan-view perspective—substantially within the area or zone corresponding to the output area, normally in a regular array or pattern within the zone. Alternatively, one can say that the light source(s) in a direct-lit backlight are disposed directly behind the output area of the backlight. A strongly diffusing plate is typically mounted above the light sources to spread light over the output area. Again, light management films, such as a reflective polarizer film, and prismatic BEF film(s), can also be placed atop the diffuser plate for improved on-axis brightness and efficiency. A disadvantage with attaining uniformity in direct-lit backlights is that the thickness of the backlight must be increased as the spacing between lamps is increased. Since the number of lamps directly impacts system cost, this trade-off is a drawback of direct-lit systems.

In the view of Applicants, drawbacks or limitations of existing direct-lit backlights include: inefficiencies associated with the strongly diffusing plate; in the case of LED sources, the need for large numbers of such sources for adequate uniformity and brightness, with associated high component cost and heat generation; and limitations on achievable thinness of the backlight beyond which light sources produce non-uniform and undesirable “punchthrough”, wherein a bright spot appears in the output area above each source. When using multicolor LED clusters such as red, green, and blue LEDs, there can also be color non-uniformities as well as brightness non-uniformities.

In some cases, a direct-lit backlight may also include one or some light sources at the periphery of the backlight, or an edge-lit backlight may include one or some light sources directly behind the output area. In such cases, the backlight is considered “direct-lit” if most of the light originates from directly behind the output area of the backlight, and “edge-lit” if most of the light originates from the periphery of the output area of the backlight.

Backlights of one type or another are usually used with liquid crystal (LC)-based displays. Liquid crystal display (LCD) panels, because of their method of operation, utilize only one polarization state of light, and hence for LCD applications it may be important to know the backlight's brightness and uniformity for light of the correct or useable polarization state, rather than simply the brightness and uniformity of light that may be unpolarized. In that regard, with all other factors being equal, a backlight that emits light predominantly or exclusively in the useable polarization state is more efficient in an LCD application than a backlight that emits unpolarized light. Nevertheless, backlights that emit light that is not exclusively in the useable polarization state, even to the extent of emitting randomly polarized light, are still fully useable in LCD applications, since the non-useable polarization state can be easily eliminated by an absorbing polarizer provided at the back of the LCD panel.

### SUMMARY

In one aspect, an illumination device is disclosed that includes a partially transmissive front reflector having an output area, a back reflector facing the front reflector, and a hollow cavity between the front and back reflectors. The illumination device also includes a first and a second light injector disposed in the hollow cavity, a transport region between the first and second light injectors, and a semi-specular element disposed in the hollow cavity. The first and second light injectors each include a first reflective surface that projects from the back reflector and faces the partially transmissive front reflector, a second reflective surface contiguous with the first reflective surface and facing the back reflector, and a light source operable to inject light between the second reflective surface and the back reflector, so that injected light is partially collimated in a first direction within 30 degrees of a transverse plane parallel to the front reflector. At least a portion of injected light from the first light injector reflects from the first reflective surface of the second light injector and is directed toward the partially transmissive front reflector.

In another aspect, an illumination device is disclosed that includes a partially transmissive front reflector having an output area, a back reflector facing the front reflector, and a hollow cavity between the front and back reflectors. The illumination device also includes a plurality of light injectors disposed in an array in the hollow cavity, and a transport region between adjacent light injectors. Each of the plurality of light injectors include a first reflective surface that projects from the back reflector and faces the partially transmissive front reflector, a second reflective surface contiguous with the first reflective surface and facing the back reflector, and a light source operable to inject light between the second reflective surface and the back reflector, so that injected light is partially collimated in a first direction within 30 degrees of a transverse plane parallel to the front reflector. The illumination device further includes a semi-specular element disposed in the hollow cavity. At least a portion of injected light from a first light injector reflects from the first reflective surface of an adjacent light injector and is directed toward the partially transmissive front reflector.

In another aspect, an illumination device is disclosed that includes a partially transmissive front reflector having an output area, a back reflector facing the partially transmissive front reflector, forming a hollow cavity between the partially transmissive front reflector and the back reflectors. The illumination device also includes a first light source operable to inject a first collimated light beam into the hollow cavity, and a light injector formed by a baffle projecting into the hollow cavity from the back reflector. The baffle includes a first reflective surface positioned to reflect a portion of the first collimated light beam toward the partially transmissive front reflector. The illumination device also includes a second light source disposed within the light injector, where the second light source is operable to inject a second collimated light beam into the hollow cavity. The illumination device also includes a transport region between the first light source and the light injector, and a semi-specular element disposed in the hollow cavity. At least a portion of injected light from the first light source reflects from the first reflective surface of the baffle and is directed toward the partially transmissive front reflector.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification reference is made to the appended drawings, where like reference numerals designate like elements, and wherein:

FIG. 1 is a schematic side view of a hollow backlight;

FIG. 1a is a perspective view of a surface, showing different planes of incidence and different polarization states;

FIG. 2 is a schematic side view of a hollow backlight including injectors;

FIG. 3 is a schematic side view of light rays within a hollow backlight including light injectors;

FIG. 4 is a schematic side view of a hollow backlight including light injectors having collimated light sources;

FIG. 5 is a schematic side view of a hollow backlight including an edgelight and light injectors;

FIG. 6 is a perspective view of an illumination backplane;

FIG. 7 is a perspective view of an illumination backplane;

FIG. 8 is a perspective view of a zoned illumination backplane;

FIG. 9 is a plot of brightness measured normal to a hollow backlight;

FIG. 10a is a schematic side view of a modeled backlight; and

FIG. 10b is a plot of brightness, normal to the modeled backlight of FIG. 10a.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

It would be beneficial for backlights to combine some or all of the following characteristics while providing a brightness and spatial uniformity that is adequate for the intended application: thin profile; design simplicity, such as a minimal number of film components and a minimal number of sources, and convenient source layout; low weight; no use of or need for film components having substantial spatial non-uniformities from one position in the backlight to another (e.g., no significant gradation); compatibility with LED sources, as well as other small area, high brightness sources such as solid state laser sources; insensitivity to problems associated with color variability among LED sources that are all nominally the same color, a process known as “binning”; to the extent possible, insensitivity to the burnout or other failure of a subset of LED sources; and the elimination or reduction of at least some of the limitations and drawbacks mentioned in the Background section above.

Whether these characteristics can be successfully incorporated into a backlight depends in part on the type of light source used for illuminating the backlight. CCFLs (Cold Cathode Fluorescent Lamps), for example, provide white light emission over their long narrow emissive areas, and those emissive areas can also operate to scatter some light impinging on the CCFL, such as would occur in a recycling cavity. The typical emission from a CCFL however has an angular distribution that is substantially Lambertian, and this may be inefficient or otherwise undesirable in a given backlight design. Also, the emissive surface of a CCFL, although somewhat diffusely reflective, also typically has an absorptive loss that Applicants have found to be significant if a highly recycling cavity is desired.

An LED (Light Emitting Diode) die also emits light in a Lambertian manner, but because of its much smaller size relative to CCFLs, the LED light distribution can be readily modified, e.g., with an integral encapsulant lens or reflector or extractor to make the resulting packaged LED a forward-emitter, a side-emitter, or other non-Lambertian profile. Examples of such extractors can be found, for example, in U.S. Pat. No. 7,304,425 (Ouderkirk et al.) and U.S. Patent Publication No. 2007/0257266 (Leatherdale et al.). Non-Lambertian profiles can provide important advantages for the disclosed backlights. However, the smaller size and higher intensity of LED sources relative to CCFLs can also make it more difficult to produce a spatially uniform backlight output area using LEDs. This is particularly true in cases where individual colored LEDs, such as arrangements of red/green/blue (RGB) LEDs, are used to produce white light, since failure to provide adequate lateral transport or mixing of such light can easily result in undesirable colored bands or areas. White light emitting LEDs, in which a phosphor is excited by a blue or UV-emitting LED die to produce intense white light from a small area or volume on the order of an LED die, can be used to reduce such color non-uniformity, but white LEDs may be unable to provide LCD color gamuts as wide as those achievable with individual colored LED arrangements, and thus may not be desirable for all end-use applications.

Applicants have discovered combinations of backlight design features that are compatible with LED source illumination, and that can produce backlight designs that outperform backlights found in state-of-the-art commercially available LCD devices in at least some respects. These backlight design features are discussed in co-pending PCT Patent Application No. US2008/064115, entitled “Recycling Backlights with Semi-specular Components”.

The backlight design can include a recycling optical cavity in which a large proportion of the light undergoes multiple reflections between substantially coextensive front and back reflectors before emerging from the front reflector, which is partially transmissive and partially reflective.

The backlight design can provide overall losses for light propagating in the recycling cavity that are kept extraordinarily low, for example, both by providing a substantially enclosed cavity of low absorptive loss, including low loss front and back reflectors as well as side reflectors, and by keeping losses associated with the light sources very low, for example, by ensuring the cumulative emitting area of all the light sources is a small fraction of the backlight output area.

The backlight design can include a recycling optical cavity that is hollow, i.e., the lateral transport of light within the cavity occurs predominantly in air, vacuum, or the like rather than in an optically dense medium such as acrylic or glass.

In the case of a backlight designed to emit only light in a particular (useable) polarization state, the front reflector can have a high enough reflectivity for such useable light to support lateral transport or spreading, and for light ray angle randomization to achieve acceptable spatial uniformity of the backlight output, but a high enough transmission into the appropriate application-useable angles to ensure application brightness of the backlight is acceptably high.

The backlight design can include a recycling optical cavity that contains a component or components that provide the cavity with a balance of specular and diffuse characteristics, the component having sufficient specularity to support significant lateral light transport or mixing within the cavity, but also having sufficient diffusivity to substantially homogenize the angular distribution of steady state light within the cavity, even when injecting light into the cavity only over a narrow range of angles. Additionally, recycling within the cavity can result in a degree of randomization of reflected light polarization relative to the incident light polarization state. This allows for a mechanism by which unusable polarization light can be converted by recycling into usable polarization light.

The backlight design can include a front reflector of the recycling cavity that has a reflectivity that generally increases with angle of incidence, and a transmission that generally decreases with angle of incidence, where the reflectivity and transmission are for unpolarized visible light and for any plane of incidence, and/or for light of a useable polarization state incident in a plane for which oblique light of the useable polarization state is p-polarized. Additionally, the front reflector has a high value of hemispheric reflectivity, and simultaneously, a sufficiently high value of transmission of application usable light.

The backlight design can include light injection optics that partially collimate or confine light initially injected into the recycling cavity to propagation directions close to a transverse plane (the transverse plane being parallel to the output area of the backlight), e.g., an injection beam having a full angle-width (about the transverse plane) at half maximum power (FWHM) in a range from 0 to 90 degrees, or 0 to 60 degrees, or 0 to 30 degrees. In some instances it may be desirable for the maximum power of the injection light to have a downward projection, below the transverse plane, at an angle with the transverse plane of no greater than 40 degrees, and in other instances, to have the maximum power of the injected light to have an upwards projection, above the transverse plane towards the front reflector, at an angle with the transverse plane of no greater than 40 degrees.

Backlights incorporating the design features discussed above and disclosed in co-pending PCT Patent Application No. US2008/064115 (Attorney Docket No. 63032WO003) provide for efficient, uniform, thin, hollow backlights. However, there may be a need to increase the surface area that can be illuminated by the backlight, while maintaining the uniformity. For at least this reason, it may be desirable to inject light at more than one location within the hollow cavity. Applicants have found that progressive injection devices can be dispersed throughout the cavity, thereby increasing the uniformly illuminated area. The backlight design can include at least one light injector (alternately referred to as light injection ports) disposed in the backlight output area. The individual light injector(s) can be positioned apart from each other by a transport zone, such that light injected into the cavity from the light injector can reflect from a combination of surfaces before exiting the backlight. One or more reflections can occur from the back reflector, the front reflector, and a surface of an adjacent light injector. In this manner, injected light is well mixed and exits the backlight uniformly.

The ability to inject light in the interior of a light guide is important for many reasons. For example, with an edgelit system lit from two opposing edges, the intensity of light generally decreases near the center of a backlight, as that is the furthest point from the light sources. As distance increases from the edge, absorptive losses increase, making it progressively difficult to achieve uniformity, particularly for very high L/H aspect ratios. Injecting light into the interior of a hollow light guide enables one to go beyond the limits of edgelighting and produce systems of extremely thin dimensions.

Another important application is zoning of LED backlights. A zoned system is a display where the emitted light is at least partially segregated into regions which can be independently controlled based on image content. Zoning is of high commercial interest to the display industry at least because of benefits in contrast improvement and large reduction in system power requirements.

Zoned backlights are also important for field sequential systems, which offer the potential to remove the color filter, improve system efficiency, and improve the quality of fast motion images. A field sequential color (FSC) display is another commercially important type of system that can benefit from zoning. In a conventional display, LCD pixels are positioned in register with absorbing color filters. Depending on image content, the LCD pixels open and close to meter the amount of light transmitted to the color filters. These absorbing filters reduce the amount of transmitted light by more than ⅔, resulting in increases in system cost due to increased number of sources, as well as increased system power, and the need for brightness enhancement films. Field sequential systems eliminate the color filter via a system that flashes Red, Green, and Blue (RGB) light in sequence, separating color temporally rather than spatially. System efficiency is increased due to removal of the color filter as well as reduction in number of pixels (⅓ as many) which improves aperture ratio. It has been found that insertion of a black frame in the color sequence can improve motion artifacts and color break-up phenomena observed in these systems. Use of FSC with a fast switching LCD panel such as OCB (Optically Compensated Birefringence) can be beneficial to reduce motion and color effects as well, as shown for example in U.S. Pat. No. 6,424,329 (Okita) and U.S. Pat. No. 6,396,469 (Miwa et al.). For zonal control, field sequential systems can use a 1-dimensional vertically scanning backlight or 2-dimensional zonal control. Wavelength control can be white, RGB, or other such as RGBCY, as shown for example in U.S. Pat. No. 7,113,152 (Ben-David et al.).

Backlights for LCD panels, in their simplest form, consist of light generation surfaces such as the active emitting surfaces of LED dies or the outer layers of phosphor in a CCFL bulb, and a geometric and optical arrangement of distributing or spreading this light in such a way as to produce an extended- or large-area illumination surface or region, referred to as the backlight output area, which is spatially uniform in its emitted brightness. Generally, this process of transforming very high brightness local sources of light into a large-area uniform output surface results in a loss of light because of interactions with all of the backlight cavity surfaces, and interaction with the light-generation surfaces. To a first approximation, any light that is not delivered by this process through the output area or surface associated with a front reflector—optionally into a desired application viewer-cone (if any), and with a particular (e.g. LCD-useable) polarization state (if any)—is “lost” light. A methodology of uniquely characterizing any backlight containing a recycling cavity by two essential parameters is described in PCT Patent Application US2008/064096 (Attorney Docket No. 63031WO003), entitled “Thin Hollow Backlights With Beneficial Design Characteristics”.

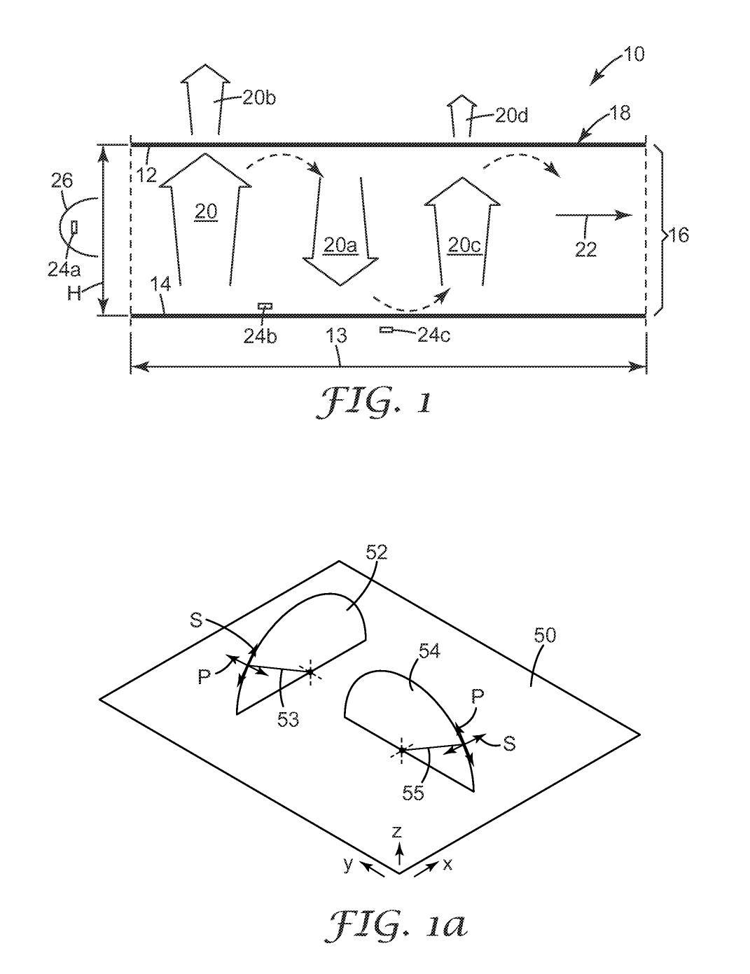

We now turn our attention to a generalized backlight 10 shown in FIG. 1, in which a front reflector 12 and a back reflector 14 form a hollow cavity 16. The backlight 10 emits light over an output area 18, which in this case corresponds to an outer major surface of the front reflector 12. The front and back reflectors are shown plane and parallel to each other, and coextensive over a transverse dimension 13, which dimension also corresponds to a transverse dimension such as a length or width of the output area 18. Although the front and back reflectors are shown plane and parallel in FIG. 1, the space between them can be variable or discontinuous, depending on the application. The front reflector reflects a substantial amount of light incident upon it from within the cavity, as shown by an initial light beam 20 being reflected into a relatively strong reflected beam 20a and a relatively weaker transmitted beam 20b. Note that the arrows representing the various beams are schematic in nature, e.g., the illustrated propagation directions and angular distributions of the different beams are not intended to be completely accurate. Returning to the figure, reflected beam 20a is strongly reflected by back reflector 14 into a beam 20c. Beam 20c is partially transmitted by front reflector 12 to produce transmitted beam 20d, and partially reflected to produce another beam (not shown). The multiple reflections between the front and back reflectors help to support transverse propagation of light within the cavity, indicated by arrow 22. The totality of all transmitted beams 20b, 20d, and so on add together incoherently to provide the backlight output.

For illustrative purposes, small area light sources 24a, 24b, 24c are shown in alternative positions in the figure, where source 24a is shown in an edge-lit position and is provided with a reflective structure 26 that can help to collimate (at least partially) light from the source 24a. Sources 24b and 24c are shown in light injection positions; both of source 24b and 24c are shown without the collimating optics that are included in light injectors (e.g., baffles as described elsewhere), and source 24c would generally be aligned with a hole or aperture (not shown) provided in the back reflector 14 to permit light injection into the hollow cavity 16. Reflective side surfaces (not shown, other than reflective structure 26) would typically also be provided generally at the endpoints of dimension 13, preferably connecting the front and back reflectors 12, 14 in a sealed fashion for minimum losses. In some embodiments generally vertical reflective side surfaces may actually be thin partitions that separate the backlight from similar or identical neighboring backlights, where each such backlight is actually a portion of a larger zoned backlight. In some embodiments, sloped reflective side surfaces can be used, to direct light as desired to front reflector 12. Light sources in the individual sub-backlights can be turned on or off, or dimmed, in any desired combination to provide patterns of illuminated and darkened zones for the larger backlight. Such zoned backlighting can be used dynamically to improve contrast and save energy in some LCD applications. In some embodiments, the zoned backlighting can be controlled by a feedback circuit in conjunction with one or more light sensors located internal to the cavity, external to the cavity, or in a combination of internal and external locations.

A backlight cavity, or more generally any lighting cavity, that converts line or point sources of light into uniform extended area sources of light can be made using a combination of reflective and transmissive optical components. In many cases, the desired cavity is very thin in comparison to its lateral dimension. Preferred cavities for providing uniform extended area light sources are those that create multiple reflections that both spread the light laterally and randomize the light ray directions. Generally, the smaller the area of the light sources compared to the area of the front face, the greater the problem in creating a uniform light intensity over the output region of the cavity.

As described elsewhere, high efficiency low-loss semi-specular reflectors can be important for facilitating optimal lateral transport of the light within the backlight cavity. Lateral transport of light can be initiated by the optical configuration of the light source; it can be induced by an extensive recycling of light rays in a cavity that utilizes low loss semi-specular reflectors; and it can be propagated for greater distances by progressively injecting light throughout the hollow cavity.

The spatially separated low loss reflectors on either side of the hollow cavity fall into two general categories. One is a partial reflector (also referred to as a partially transmissive reflector) for the front face and the second is a full reflector for the back and side faces. For optimal transport of light and mixing of light in the cavity, both the front and back reflectors may be specular or semi-specular instead of Lambertian; a semi-specular component of some type is useful somewhere within the cavity to promote uniform mixing of the light. The use of air as the main medium for lateral transport of light in large light guides enables the design of lighter, thinner, lower cost, and more uniform display backlights.

For a hollow light guide to significantly promote the lateral spreading of light, the means of light injection into the cavity is important, just as it is in solid light guides. The format of a hollow light guide allows for more options for injecting light at various points in a direct lit backlight, especially in backlights with multiple but optically isolated zones. In a hollow light guide system, the function of TIR and Lambertian reflectors can be accomplished with the combination of a specular reflector and a semi-specular, forward scattering diffusion element. As described elsewhere, excessive use of Lambertian scattering elements is not considered optimal.

Exemplary partial reflectors (front reflectors) we describe here—particularly, for example, the asymmetric reflective films (ARFs) described in PCT Patent Application No. US2008/064133 (Attorney Docket No. 63274WO004) entitled “Backlight and Display System Using Same”—provide for low loss reflections and also for better control of transmission and reflection of polarized light than is possible with TIR in a solid light guide alone. Thus, in addition to improved light distribution laterally across the face of the display, the hollow light guide can also provide for improved polarization control for large systems. Significant control of transmission with angle of incidence is also possible with the preferred ARFs mentioned above. In this manner, light from the mixing cavity can be collimated to a significant degree as well as providing for a polarized light output with a single film construction.

Preferred front reflectors have a relatively high overall reflectivity, to support relatively high recycling within the cavity. We characterize this in terms of “hemispheric reflectivity”, meaning the total reflectivity of a component (whether a surface, film, or collection of films) when light is incident on it from all possible directions. Thus, the component is illuminated with light incident from all directions (and all polarization states, unless otherwise specified) within a hemisphere centered about a normal direction, and all light reflected into that same hemisphere is collected. The ratio of the total flux of the reflected light to the total flux of the incident light yields the hemispheric reflectivity, Rₕₑₘᵢ. Characterizing a reflector in terms of its Rₕₑₘᵢ is especially convenient for recycling cavities because light is generally incident on the internal surfaces of the cavity—whether the front reflector, back reflector, or side reflectors—at all angles. Further, unlike the reflectivity for normal incidence, Rₕₑₘᵢ is insensitive to, and already takes into account, the variability of reflectivity with incidence angle, which may be very significant for some components (e.g., prismatic films). Front reflectors can be a single component or a combination of components, such as a stack of optical films, to deliver the required Rₕₑₘᵢ.

In fact, preferred front reflectors exhibit a (direction-specific) reflectivity that increases with incidence angle away from the normal (and a transmission that generally decreases with angle of incidence), at least for light incident in one plane. Such reflective properties cause the light to be preferentially transmitted out of the front reflector at angles closer to the normal, i.e., closer to the viewing axis of the backlight, and this helps to increase the perceived brightness of the display at viewing angles that are important in the display industry (at the expense of lower perceived brightness at higher viewing angles, which are usually less important). We say that the increasing reflectivity with angle behavior is “at least for light incident in one plane”, because sometimes a narrow viewing angle is desired for only one viewing plane, and a wider viewing angle is desired in the orthogonal plane. An example is some LCD TV applications, where a wide viewing angle is desired for viewing in the horizontal plane, but a narrower viewing angle is specified for the vertical plane. In other cases narrow angle viewing is desirable in both orthogonal planes so as to maximize on-axis brightness.

When we discuss oblique angle reflectivity, it is helpful to keep in mind the geometrical considerations of FIG. 1a. There, we see a surface 50 that lies in an x-y plane, with a z-axis normal direction. If the surface is a polarizing film or partially polarizing film such as the ARFs described in PCT Patent Application No. US2008/064133 (Attorney Docket No. 63274WO004), we designate for purposes of this application the y-axis as the “pass axis” and the x-axis as the “block axis”. In other words, if the film is a polarizing film, normally incident light whose polarization axis is parallel to the y-axis is preferentially transmitted compared to normally incident light whose polarization axis is parallel to the x-axis. Of course, in general, the surface 50 need not be a polarizing film.

Light can be incident on surface 50 from any direction, but we concentrate on a first plane of incidence 52, parallel to the x-z plane, and a second plane of incidence 54, parallel to the y-z plane. “Plane of incidence” of course refers to a plane containing the surface normal and a particular direction of light propagation. We show in the figure one oblique light ray 53 incident in the plane 52, and another oblique light ray 55 incident in the plane 54. Assuming the light rays to be unpolarized, they will each have a polarization component that lies in their respective planes of incidence (referred to as “p-polarized” light and labeled “p” in the figure), and an orthogonal polarization component that is oriented perpendicular to the respective plane of incidence (referred to as “s-polarized light” and labeled “s” in the figure). It is important to note that for polarizing surfaces, “s” and “p” can be aligned with either the pass axis or the block axis, depending on the direction of the light ray. In the figure, the s-polarization component of ray 53, and the p-polarization component of ray 55, are aligned with the pass axis (the y-axis) and thus would be preferentially transmitted, while the opposite polarization components (p-polarization of ray 53, and s-polarization of ray 55) are aligned with the block axis.

With this in mind, let us consider the meaning of specifying (if we desire) that the front reflector “exhibit a reflectivity that generally increases with angle of incidence”, in the case where the front reflector is an ARF such as is described in PCT Patent Application No. US2008/064133, referenced elsewhere. The ARF includes a multilayer construction (e.g., coextruded polymer microlayers that have been oriented under suitable conditions to produce desired refractive index relationships, and desired reflectivity characteristics) having a very high reflectivity for normally incident light in the block polarization state and a lower but still substantial reflectivity (e.g., 25 to 90%) for normally incident light in the pass polarization state. The very high reflectivity of block-state light (p-polarized component of ray 53, and s-polarized component of ray 55) generally remains very high for all incidence angles. The more interesting behavior is for the pass-state light (s-polarized component of ray 53, and p-polarized component of ray 55), since that exhibits an intermediate reflectivity at normal incidence. Oblique pass-state light in the plane of incidence 52 will exhibit an increasing reflectivity with increasing incidence angle, due to the nature of s-polarized light reflectivity (the relative amount of increase, however, will depend on the initial value of pass-state reflectivity at normal incidence). Thus, light emitted from the ARF film in a viewing plane parallel to plane 52 will be partially collimated or confined in angle. Oblique pass-state light in the other plane of incidence 54 (i.e., the p-polarized component of ray 55), however, can exhibit any of three behaviors depending on the magnitude and polarity of the z-axis refractive index difference between microlayers relative to the in-plane refractive index differences, as discussed in PCT Patent Application No. US2008/064133.

In one case, a Brewster angle exists, and the reflectivity of this light decreases with increasing incidence angle. This produces bright off-axis lobes in a viewing plane parallel to plane 54, which are usually undesirable in LCD viewing applications (although in other applications this behavior may be acceptable, and even in the case of LCD viewing applications this lobed output may be re-directed towards the viewing axis with the use of a prismatic turning film).

In another case, a Brewster angle does not exist or is very large, and the reflectivity of the p-polarized light is relatively constant with increasing incidence angle. This produces a relatively wide viewing angle in the referenced viewing plane.

In the third case, no Brewster angle exists, and the reflectivity of the p-polarized light increases significantly with incidence angle. This can produce a relatively narrow viewing angle in the referenced viewing plane, where the degree of collimation is tailored at least in part by controlling the magnitude of the z-axis refractive index difference between microlayers in the ARF.

Of course, the reflective surface 50 need not have asymmetric on-axis polarizing properties as with ARF. Symmetric multilayer reflectors, for example, can be designed to have a high reflectivity but with substantial transmission by appropriate choice of the number of microlayers, layer thickness profile, refractive indices, and so forth. In such a case the s-polarized components of both ray 53 and 55 will increase with incidence angle, in the same manner with each other. Again, this is due to the nature of s-polarized light reflectivity, but the relative amount of increase will depend on the initial value of the normal incidence reflectivity. The p-polarized components of both ray 53 and ray 55 will have the same angular behavior as each other, but this behavior can be controlled to be any of the three cases mentioned above by controlling the magnitude and polarity of the z-axis refractive index difference between microlayers relative to the in-plane refractive index differences, as discussed in PCT Patent Application No. US2008/064133.

Thus, we see that the increase in reflectivity with incidence angle (if present) in the front reflector can refer to light of a useable polarization state incident in a plane for which oblique light of the useable polarization state is p-polarized. Alternately, such increase in reflectivity can refer to the average reflectivity of unpolarized light, in any plane of incidence.

Preferred back reflectors also have a high hemispherical reflectivity for visible light, typically, much higher than the front reflector since the front reflector is deliberately designed to be partially transmissive in order to provide the required light output of the backlight. The hemispherical reflectivity of the back reflector is referred to as R^{b}ₕₑₘᵢ, while that of the front reflector is referred to as R^{f}ₕₑₘᵢ. Preferably, the product R^{f}ₕₑₘᵢ*R^{b}ₕₑₘᵢ is at least 55% (0.55), or 65%, or 80%.

There are several aspects to the design of a hollow cavity that are relevant to spreading light efficiently and uniformly from small area sources to the full area of the output region. These are 1) proper directional injection of light into the cavity from the light sources; 2) the use of forward scattering diffusers or semi-specular reflecting surfaces or components within the cavity; 3) a front reflector that transmits the light, but which is also substantially reflective such that most light rays are recycled many times between the front and back reflector so as to eventually randomize the light ray directions within the cavity; and 4) minimizing losses by optimal component design.

Conventional backlights have used one or more of these techniques to enhance the uniformity of the backlight, but never all four simultaneously in the correct configuration for a thin and hollow backlight having very small area light sources. These aspects of cavity design are examined in more detail below.

A more uniform hollow backlight can be made by using a partially collimated light source, or a Lambertian source with collimating optical means, in order to produce a highly directional source that promotes the lateral transport of light. Examples of suitable light injectors for edge-injection light are described in PCT Patent Application No. US2008/064125 (Attorney Docket No. 63034WO004) entitled “Collimating Light Injectors for Edge-Lit Backlights”. The light rays are preferably injected into a hollow light guide with a predominantly horizontal direction, i.e., having a relatively small deviation angle relative to a plane that is transverse to the viewing axis of the backlight. Some finite distribution of ray angles cannot be avoided, and this distribution can be optimized by the shape of the collimating optics in conjunction with the emission pattern of the light source to maintain the uniformity of the light across the output area of the cavity. The partially reflecting front reflector and the partial diffusion of the semi-specular reflector produces a light recycling and randomizing light cavity that works in harmony with the injection optics to create a uniform, thin, and efficient hollow light guide.

In direct-lit systems it is generally preferable that only small amounts of the light from a given light source are directly incident on the front reflector in regions of the output area directly opposing that source. One approach for achieving this is a packaged LED or the like, positioned in the cavity and designed to emit light mostly in the lateral directions. This feature is typically achieved by the optical design of the LED package, specifically, the encapsulant lens. Another approach is to place a baffle above the LED to block its line of sight of the front reflector. As discussed herein, the combination of a light source (e.g., an LED) and a baffle used to block the line of sight of a light source with the front reflector is referred to collectively as a “light injector”. The baffle typically will include a high efficiency reflective surface on one or both sides of the baffle to reflect light toward the front reflector. The high efficiency reflective surface can be planar, or curved in a convex shape so as to spread the reflected light away from the source so it is not reabsorbed. This arrangement also imparts substantial lateral components to the light ray direction vectors. Still another approach is covering the light source with a baffle including a piece of a reflective polarizer that is misaligned with respect to a polarization pass axis of the front reflector. The light transmitted by the local reflective polarizer proceeds to the front reflector where it is mostly reflected and recycled, thereby inducing a substantial lateral spreading of the light. Reference is made in this regard to U.S. Application Publication No. 2006/0187650 (Epstein et al.), entitled “Direct Lit Backlight with Light Recycling and Source Polarizers”.

There may be instances where Lambertian emitting LEDs are preferred in a direct-lit backlight for reasons of manufacturing cost or efficiency. Good uniformity may still be achieved with such a cavity by imposing a greater degree of recycling in the cavity. This may be achieved by using a front reflector that is even more highly reflective, e.g., having less than about 10% or 20% total transmission. For a polarized backlight, this arrangement further calls for a block axis of the front reflector having a very low transmission, on the order of 1% to 2% or less. An extreme amount of recycling, however, may lead to unacceptable losses in the cavity.

Having reviewed some of the benefits and design challenges of hollow cavities, we now turn to a detailed explanation of semi-specular reflective and transmissive components, and advantages of using them rather than solely Lambertian or specular components in hollow recycling cavity backlights.

A pure specular reflector, sometimes referred to as a mirror, performs according to the optical rule that states, “the angle of incidence equals the angle of reflection.” In one aspect, the front and back reflector are both purely specular. A small portion of an initially launched oblique light ray is transmitted through the front reflector, but the remainder is reflected at an equal angle to the back reflector, and reflected again at an equal angle to the front reflector, and so on. This arrangement provides maximum lateral transport of the light across the cavity, since the recycled ray is unimpeded in its lateral transit of the cavity. However, no angular mixing occurs in the cavity, since there is no mechanism to convert light propagating at a given incidence angle to other incidence angles.

A purely Lambertian reflector, on the other hand, redirects light rays equally in all directions. The same initially launched oblique light ray is immediately scattered in all directions by the front reflector, most of the scattered light being reflected back into the cavity but some being transmitted through the front reflector. Some of the reflected light travels “forward” (generally in the launch direction), but an equal amount travels “backward”. By forward scattering, we refer to the lateral or in-plane (in a plane parallel to the scattering surface in question) propagation components of the reflected light. When repeated, this process greatly diminishes the forward directed component of a light ray after several reflections. The beam is rapidly dispersed, producing minimal lateral transport.

A semi-specular reflector provides a balance of specular and diffusive properties. For example, we consider the case where the front reflector is purely specular, but the back reflector is semi-specular. The reflected portion of the same initially launched oblique light ray strikes the back reflector, and is substantially forward-scattered in a controlled amount. The reflected cone of light is then partially transmitted but mostly reflected (specularly) back to the back reflector, all while still propagating to a great extent in the “forward” direction.

Semi-specular reflectors can thus be seen to promote the lateral spreading of light across the recycling cavity, while still providing adequate mixing of light ray directions and polarization. Reflectors that are partially diffuse but that have a substantially forward directed component will transport more light across a greater distance with fewer total reflections of the light rays. In a qualitative way, we can describe a semi-specular reflector as one that provides substantially more forward scattering than reverse scattering. A semi-specular diffuser can be defined as one that does not reverse the normal component of the ray direction for a substantial majority of the incident light, i.e., the light is substantially transmitted in the forward direction and scattered to some degree in the orthogonal directions. A more quantitative description of semi-specular is provided in PCT Patent Application No. US2008/064115 (Attorney Docket No. 63032WO003).

Whether the semi-specular element is an integral part of either reflector, or laminated to either reflector, or placed in the cavity as a separate component, the overall desired optical performance is one with an angular spreading function that is substantially narrower than a Lambertian distribution for a ray that completes one round trip passage from the back reflector to the front and back again. It is preferred that the cavity be semi-specular, and as such, a semi-specular element can be a separate element between the front and back reflector, it can be attached to either the front or back reflector, or it can be disposed in a combination of positions. A semi-specular reflector can have characteristics of both a specular and a Lambertian reflector or can be a well defined Gaussian cone about the specular direction. The performance depends greatly on how it is constructed. Keeping in mind that the diffuser component can also be separate from the reflector, several possible constructions exist for the back reflector and for the high efficiency reflective surface(s) on the baffle, such as:

1) partial transmitting specular reflector plus a high reflectance diffuse reflector;

2) partial Lambertian diffuser covering a high reflectance specular reflector;

3) forward scattering diffuser plus a high reflectance specular reflector; or

4) corrugated high reflectance specular reflector.

For each numbered construction, the first element listed is arranged to be inside the cavity. The first element of constructions 1 through 3 can be continuous or discontinuous over the area of the back reflector and the light injector baffles as described elsewhere. In addition, the first element could have a gradation of diffuser properties, or could be printed or coated with additional diffuser patterns that are graded. The graded diffuser is optional, but may be desirable to optimize the efficiency of various backlight systems. The term “partial Lambertian” is defined to mean an element that only scatters some of the incident light. The fraction of light that is scattered by such an element is directed almost uniformly in all directions. In construction 1), the partial specular reflector is a different component than that utilized for the front reflector. The partial reflector in this case can be either a spatially uniform film of moderate reflectivity, or it can be a spatially non-uniform reflector such as a perforated multilayer or metallic reflector. The degree of specularity can be adjusted either by changing the size and number of the perforations, or by changing the base reflectivity of the film, or both.

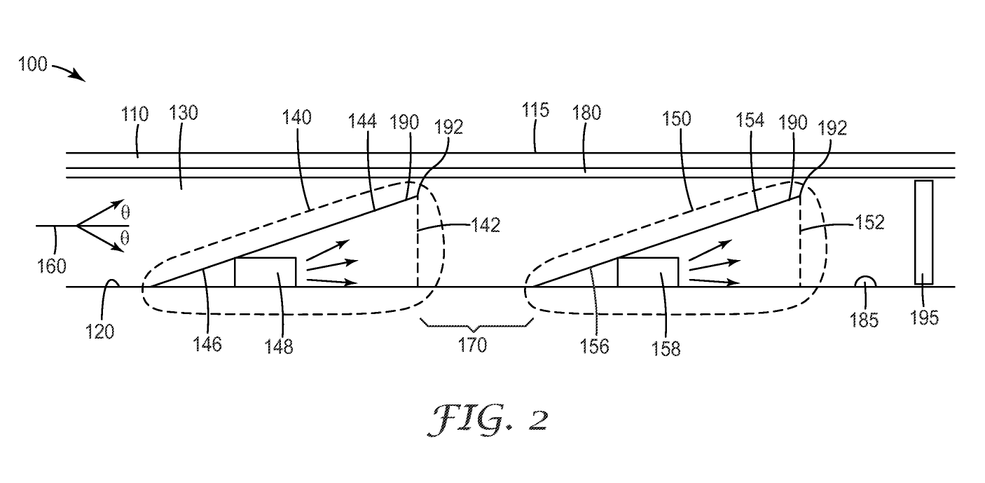

In one aspect, FIG. 2 shows an illumination device 100 which includes a partially transmissive front reflector 110 having an output surface 115, and a back reflector 120 that is spaced apart from the partially transmissive front reflector 110 to form a hollow cavity 130 between them. A reflective side element 195 can be positioned within the cavity as shown, to define an edge or boundary of illumination device 100, or can be used to separate different portions of illumination device 100 as described elsewhere. A semi-specular element 180 is disposed within hollow cavity 130. As shown in FIG. 2, the semi-specular element is positioned adjacent the partially transmissive front reflector 110; however, the semi-specular element can be placed at any location within hollow cavity 130, and can even be a part of other reflective elements within the cavity, as discussed elsewhere.

A first and a second light injector 140 and 150, project into hollow cavity 130 from back reflector 120. The boundaries of the first and second light injectors 140 and 150 within hollow cavity 130 are each defined by a baffle 190 which projects from back reflector 120, and an exit aperture 142, 152 that is a line that connects a baffle edge 192 with back reflector 120. Baffle 190 can be planar, such as a sheet or film; baffle 190 can instead have a curved shape in one or more directions, such as a parabola, paraboloid, ellipse, ellipsoid, compound parabola, hood, and the like, as described elsewhere. In some embodiments, light injectors 140, 150 can be any collimating light engines described in co-pending Attorney Docket No. 64131US002 entitled “Collimating Light Engine”, filed on an even date herewith. Exit apertures 142, 152 are positioned in a perpendicular direction from partially transmissive front reflector 110.

A transport region 170 is defined between exit aperture 142 of first light injector 140, and the point of contact of baffle 190 of second light injector 150 with the back reflector 120. Transport region 170 is used to further provide mixing of light within hollow cavity 130, as described elsewhere. In some embodiments, a light spreading film (not shown) can be disposed proximate the exit aperture 142, 152 to control lateral spreading (i.e. spreading in a plane generally parallel to back reflector 120) of light from the injectors 140, 150.

The baffle edge 192 of each of the baffles 190 can be spaced apart from partially transmissive front reflector 110 as shown in FIG. 2, or it can extend to contact the partially transmissive front reflector 110 (not shown). The separation of the baffle edge 192 from partially transmissive front reflector can be adjusted as desired, to provide for further mixing of light from the first light injector 140 with light from the second light injector 150. In some cases, it may be desirable to isolate light from the first light injector 140 from light from the second light injector 150, and each of the baffles 190 will have baffle edges 192 in contact with transmissive front reflector. In some cases, it may be desirable to provide some level of mixing, and the baffle edges 192 can be separated from the partially transmissive front reflector 110 so that light from one injector can pass through this separation to mix with light from another injector. This separation can be open space, or a partially transmissive film portion. The partially transmissive film portion can be, for example, a perforated film, a slit film, a partial reflector, reflective polarizer, a film having variations in reflection and transmission over different regions, and the like, but in general it exhibits differing regions of transmissivity.

At one or more positions within the hollow cavity 130, a light sensor 185 can be placed to monitor the light intensity, and any one or several of the light sources can be adjusted by, for example, a feedback circuit. Control of the light intensity can be either manual or automatic, and can be used to independently control the light output of various regions of the illumination device.

First and second light injectors 140, 150 include a first reflective surface 144, 154 disposed on baffle 190 and facing partially transmissive front reflector 110, a second reflective surface 146, 156 disposed on baffle 190 and facing back reflector 120, and a light source 148, 158 operable to inject light into hollow cavity 130. First and second reflective surfaces can be surface reflectors, such as a metallized mirror, and can also be volume reflectors, such as a multilayer interference reflector. First and second reflective surfaces can be contiguous, including a film having two opposing surfaces, a film which has been formed or folded so that the first surface becomes the second surface after the fold line, or two separate films that are joined along at least one common edge. In one embodiment, first and second reflective surfaces can be mounted on a substrate that provides mechanical support for the baffle. Second reflective surface 146, 156 can be a highly reflective surface, if the light sources 148, 158 direct light rays toward this surface. In some cases, discussed elsewhere, light source 148, 158 are configured so that light will generally not be required to reflect from second reflective surface 146, 156, and therefore the surfaces need not be highly reflective.

The light sources 148 and 158 are positioned within light injectors 140 and 150 so that partially collimated light can be injected into hollow cavity 130. As used herein, “partially collimated” indicates that the light travels within hollow cavity 130 within a propagation direction close to a transverse plane 160 generally parallel to partially transmissive front reflector 110. As discussed elsewhere, light traveling within hollow cavity 130 can propagate for a relatively long distance if the light intercepts the partially transmissive front reflector 110 at angles θ from 0 to 40 degrees, or 0 to 30 degrees, or 0 to 15 degrees from grazing incidence.

The illumination device can include any suitable front reflector including, e.g., ARF; multilayer reflectors including, e.g., perforated mirrors such as a perforated Enhanced Specular Reflecting (ESR, available from 3M Company) film; metal reflectors including, e.g., thin film enhanced metal films; diffusive reflectors including, e.g., asymmetric DRPF (diffuse reflective polarizer film available from 3M Company); and combinations of films, including those described in PCT Patent Application US2008/064096 (Attorney Docket No. 63031WO003).

The illumination device can include any suitable back reflector and baffle. In some cases, the back reflector and baffle (including the first reflective surface, and the second reflective surface) can be made from a stiff metal substrate with a high reflectivity coating, or a high reflectivity film which can be laminated to a supporting substrate. Suitable high reflectivity materials include Vikuiti™ Enhanced Specular Reflector (ESR) multilayer polymeric film available from 3M Company; a film made by laminating a barium sulfate-loaded polyethylene terephthalate film (2 mils thick) to Vikuiti™ ESR film using a 0.4 mil thick isooctylacrylate acrylic acid pressure sensitive adhesive, the resulting laminate film referred to herein as “EDR II” film; E-60 series Lumirror™ polyester film available from Toray Industries, Inc.; porous polytetrafluoroethylene (PTFE) films, such as those available from W. L. Gore & Associates, Inc.; Spectralon™ reflectance material available from Labsphere, Inc.; Miro™ anodized aluminum films (including Miro™ 2 film) available from Alanod Aluminum-Veredlung GmbH & Co.; MCPET high reflectivity foamed sheeting from Furukawa Electric Co., Ltd.; White Refstar™ films and MT films available from Mitsui Chemicals, Inc.; and others including those described in PCT Patent Application US2008/064096.

The illumination device can include any suitable light source including, e.g., a surface emitting LED, such as a blue- or UV emitting-LED with a down-converting phosphor to emit white light hemispherically from the surface; individual colored LEDs, such as arrangements of red/green/blue (RGB) LEDs; and others such as described in PCT Patent Application US2008/064133 entitled “Backlight and Display System Using Same”. Other visible light emitters such as linear cold cathode fluorescent lamps (CCFLs) or hot cathode fluorescent lamps (HCFLs) can be used instead of or in addition to discrete LED sources as light sources for the disclosed illumination devices. In addition, hybrid systems such as, for example, (CCFL/LED), including cool white and warm white, CCFL/HCFL, such as those that emit different spectra, may be used. The combinations of light emitters may vary widely, and include LEDs and CCFLs, and pluralities such as, for example, multiple CCFLs, multiple CCFLs of different colors, and LEDs and CCFLs.

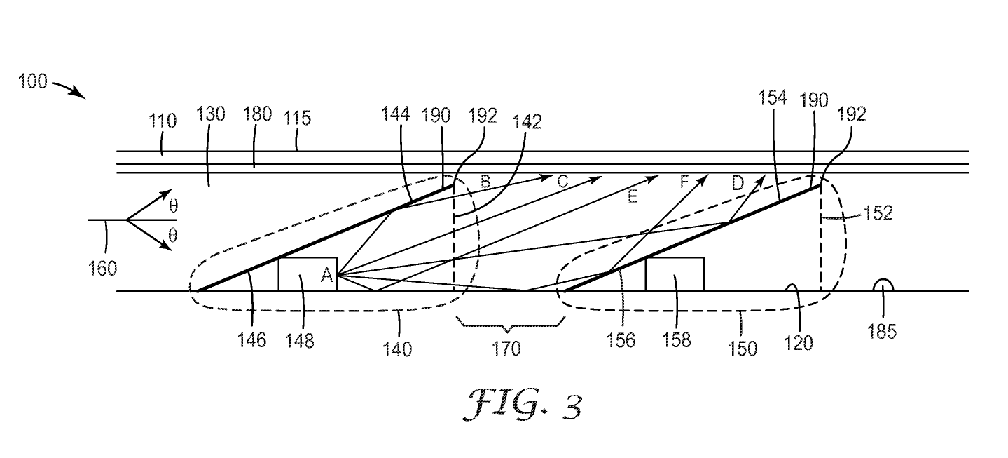

FIG. 3 shows the path of several representative light rays within illumination device 100. Light rays AB, AC, AD, AE, and AF are injected into hollow cavity 130 by light source 148 disposed within first light injector 140. In FIG. 3, light source 148 is shown to be positioned between baffle 190 and a back reflector 120, and injects light in a direction generally along the length of the hollow cavity. In one embodiment, light source 148 can be located below the plane defined by back reflector 120, and positioned to inject light generally perpendicularly to the length of the hollow cavity, to reflect from baffle 190 and be re-directed along the length of the hollow cavity (not shown).

Light source 148 can be a surface emitting LED, for example a blue- or UV emitting-LED with a down-converting phosphor to emit white light hemispherically from the surface. In the case of such a surface-emitting LED: first light ray AB reflects from second reflective surface 146 of baffle 190, and is directed toward partially transmissive front reflector 110. A second light ray AC is directed toward partially transmissive front reflector 110 without reflection. A third light ray AD reflects from first reflective surface 154 of baffle 190 (of second light injector 150), and is directed toward partially transmissive front reflector 110. A fourth light ray AE reflects from back reflector 120 within first light injector 140, and is directed toward partially transmissive front reflector 110. A fifth light ray AF reflects from back reflector within transport region 170, reflects from first reflective surface 154 of baffle 190 (of second light injector 150), and is directed toward partially transmissive front reflector 110. Baffle 190 is positioned so that light rays from first light source 148 are generally confined to travel through hollow cavity 130 within a range of angles θ close the transverse plane 160 as described elsewhere.

FIG. 3 shows that light injected from the light injector can undergo a variety of reflections before being directed to partially transmissive front reflector (where the light will undergo further reflection and transmission as described elsewhere). The combination of these interactions with different surfaces provide for a homogenization of the light so that non-uniformities can be minimized. Further, the transport region 170 can provide additional mixing, as well as providing physical separation between sources. The baffles placed within the hollow cavity serve to “hide” the LED sources from the output surface 115, blocking the direct line of sight view of the sources.

As described elsewhere, the material properties of the partially transmissive front reflector improve the emitted light uniformity, but as the length of the transport region increases, there is a decrease of radiation flux through the hollow cavity, resulting in a decrease in the brightness of the illumination device. For at least this reason, progressively more light is injected through additional injection ports to increase the radiation flux and extend the useable length of the backlight.

At one or more positions within the hollow cavity, a light sensor 185 can be placed to monitor the light intensity or color, and any one or several of the light sources can be adjusted by, for example, a feedback circuit. Control of the light intensity or color can be either manual or automatic, and can be used to independently control the light output of various regions of the illumination device.

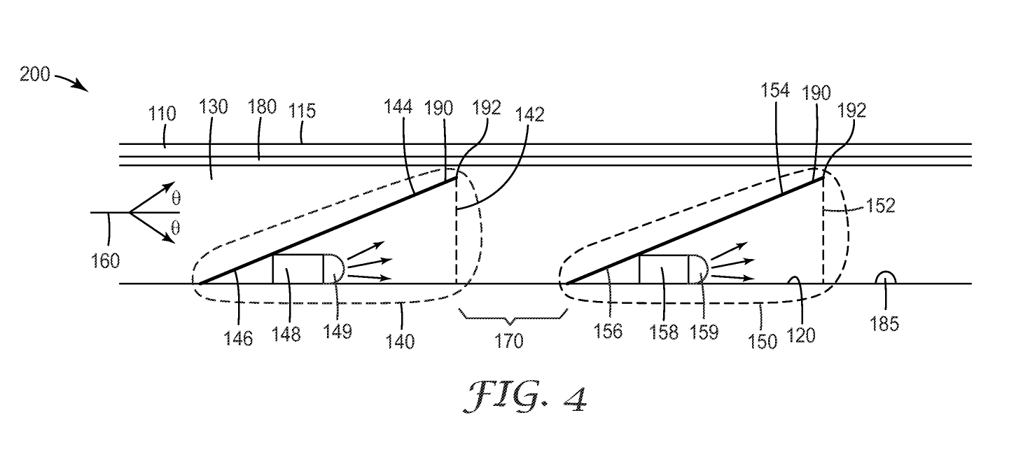

Turning now to FIG. 4, an illumination device 200 according to one aspect is described. In this embodiment, light sources 148 and 158 are LED devices that have associated collimating optics 149, 159. Collimating optics 149, 159 can be for example resin based encapsulants that form a lens over the LED output. Light rays exiting the collimating optics remain within a narrow spread of angles relative to the transverse plane 160, and do not require reflections from either the second reflective surface 146, 156 of baffles 190, or from the portion of back reflector 120 within the light injector. Injected light rays can follow several different paths before exiting the output surface 115. For example, light can be incident upon the transport region 170, the first reflective surface 154 of baffle 190, and the partially transmissive front reflector 110.

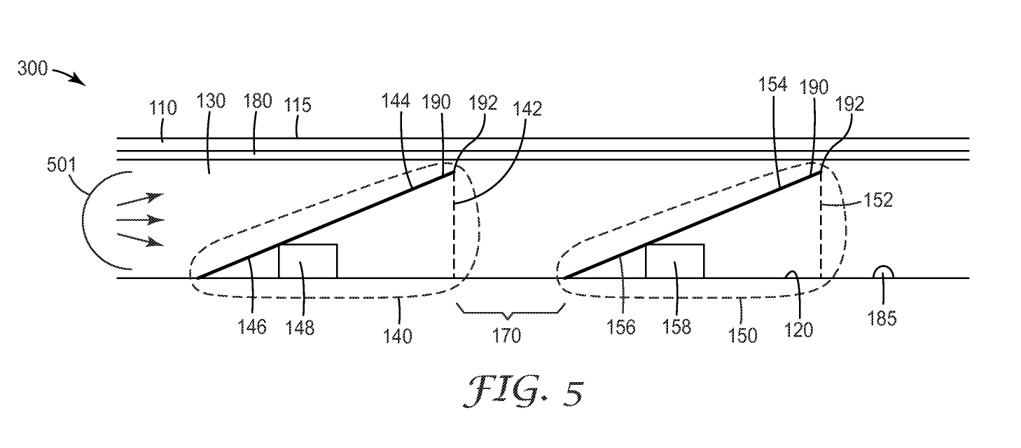

FIG. 5 shows an illumination device 300 that includes a combination of an edge-light source 501 and light injectors 140, 150. FIG. 5 shows the increase in the areal size of the illumination device by progressive injection of light. Edgelight source 501 can be a conventional edge-light coupled to the hollow cavity as described, for example, in PCT Patent Application No. US2008/064125 (Attorney Docket No. 63034WO004) entitled “Collimating Light Injectors for Edge-Lit Backlights”. In FIG. 5, additional light injectors 140 and 150 are placed at positions to inject additional light and also re-direct light injected from another portion of the display. One or more light sensors 185 placed within the illumination device can monitor the intensity of light within the hollow cavity, and can be used to adjust the light sources to provide a desired intensity and uniformity.

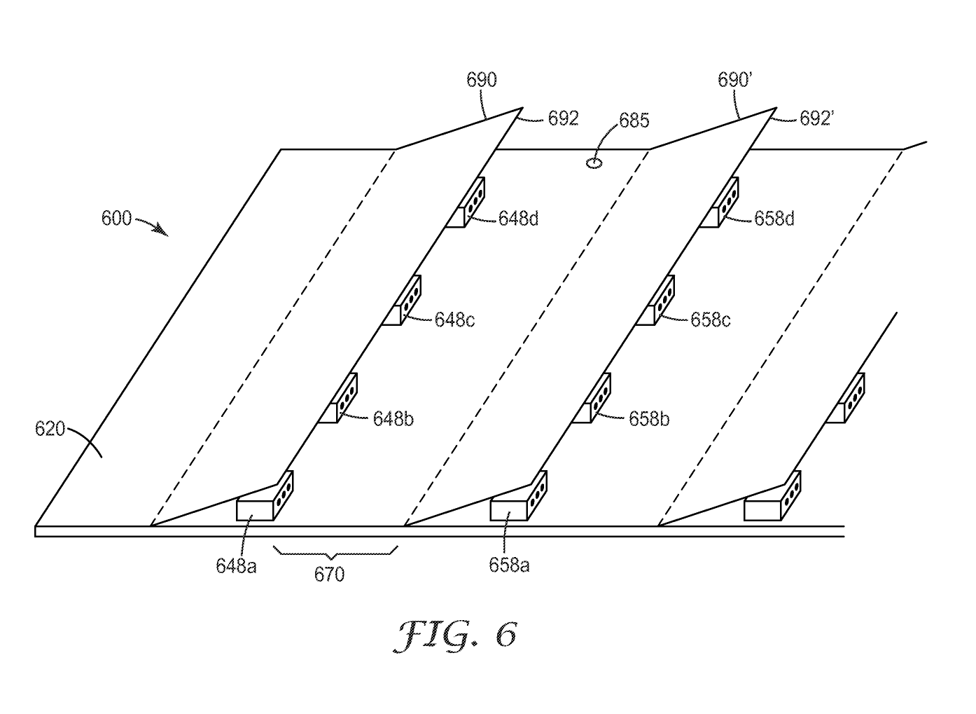

The illumination devices described herein can be assembled into a larger array of devices disposed on a backplane that can be suitable, for example, for use in a display or lighting application. In one aspect, FIG. 6 is a perspective view of illumination device backplane 600 having back reflector 620, used with a partially transmissive front reflector (not shown). According to this aspect, a plurality of first light sources 648a-648d are disposed beneath first light injector baffle 690 which extends longitudinally across device backplane 600, in a direction essentially parallel to an edge of the device backplane. A plurality of second light sources 658a-658d are disposed beneath second light injector baffle 690′, in a direction essentially parallel to the first light injector. Second light injector is displaced from first light injector by transport region 670. One or more light sensors 685 can be placed proximate the backplane to monitor light generated by the device backplane. Baffle edges 692, 692′ can be used to mechanically support the partially transmissive front reflector, if desired. For clarity, FIG. 6 shows light sources placed near the baffle edges; however, it is to be understood that the light sources are disposed further under the baffles, as described elsewhere. The illumination device backplane 600 can be used with any illumination device described herein, e.g., illumination device 200 as shown in FIG. 2.

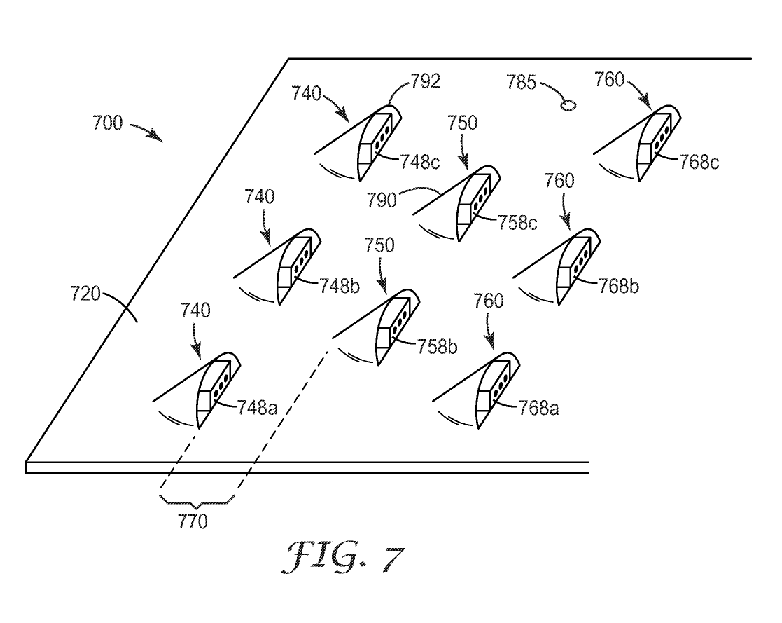

In another aspect, FIG. 7 is a perspective view of an illumination device backplane 700 having back reflector 720, used with a partially transmissive front reflector (not shown). According to this aspect, a plurality of first light sources 748a-c are disposed within first light injectors 740; a plurality of second light sources 758b-c are disposed within second light injectors 750; and a plurality of third light sources 768a-c are disposed within third light injectors 760. The array of light injectors shown in FIG. 7 can be extended to cover any desired portion of the illumination device backplane 700. Each of the light injectors 740, 750 and 760 include baffles in the shape of hoods, which can be formed, for example, by punching and deforming the back reflector 720. Each light injector is displaced from an adjacent light injector by transport region 770. One or more light sensors 785 can be placed to monitor light generated by the device backplane. Baffle edges 792 can be used to mechanically support the partially transmissive front reflector, if desired. For clarity, FIG. 7 shows light sources placed near the baffle edges; however, it is to be understood that the light sources are disposed further under the baffles, as described elsewhere. The illumination device backplane 700 can be used with any illumination device described herein, e.g., illumination device 200 as shown in FIG. 2.

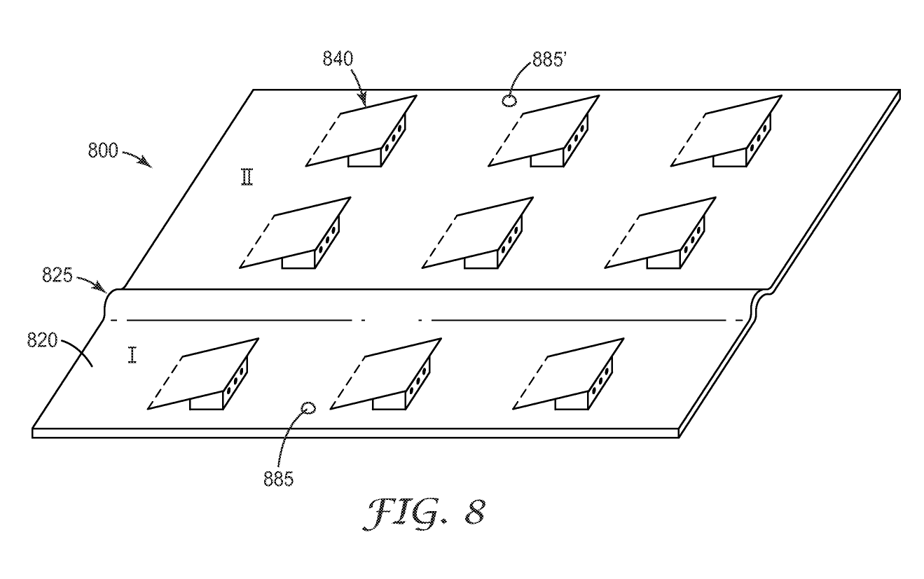

In another aspect, FIG. 8 is a perspective view of a zoned illumination device backplane 800, used with a partially transmissive front reflector (not shown). According to this aspect, a plurality of light injectors 840 is disposed in an array over the back reflector 820, and the back reflector 820 is divided into a first zone I and a second zone II by a ridge 825 separating the two zones. The zoned illumination device can be divided into multiple zones if desired, by placement of multiple ridges separating different portions of light injector array. One or more light sensors 885 and 885′ are disposed in each of the zones, to allow independent monitoring of the light intensity in each zone.

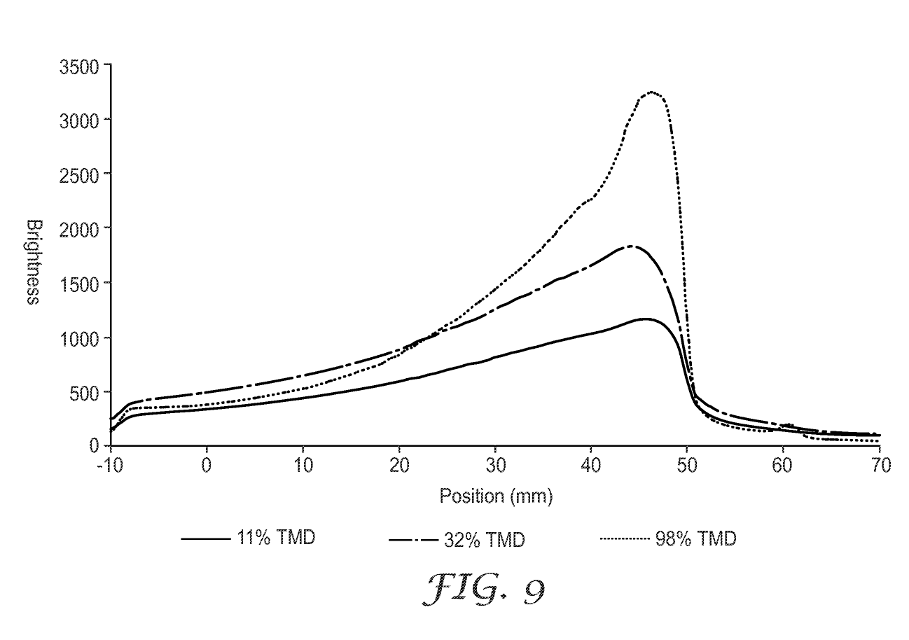

The hemispherical reflectivity of the front reflector, R^{f}ₕₑₘᵢ, can have a significant impact on the spreading of light emitted by a light source. As R^{f}ₕₑₘᵢ increases, less light is transmitted through the front reflector with each reflection, and therefore light is spread over a larger area within the hollow cavity due to multiple reflections. FIG. 9 is a plot of the brightness measured normal to the front reflector, as a function of the centerline distance from the exit aperture of a light injector, for three front reflector films with different R^{f}ₕₑₘᵢ values. As R^{f}ₕₑₘᵢ increases, the variation in brightness decreases from the exit aperture, with a concomitant increase in the spreading of light laterally from the centerline.

### EXAMPLES

Film-based light injectors were constructed according to the procedure described in co-pending U.S. Patent Application corresponding to Attorney Docket No. 64131US002 entitled “Collimating Light Engine”, filed on an even date herewith. These light injectors were disposed on a backplane in various configurations as described below. The backplane used was an ESR film backplane which had been previously laminated to a 0.004″ (0.16 mm) thick stainless steel shim stock.

### Example 1

### Total Luminous Flux of Film-Based Injectors

The total luminous flux (TLF) of a film-based light injector was measured in an Optronic integrating sphere by peeling back the upper ESR film that forms the wedge, fully exposing the LEDs so that they could emit into the sphere without obstruction. The TLF was measured to be 49.94 lumens when driven at 19.8 V and 30 mA, and this TLF value was taken to represent 100% of the ideal light emission from the light engine. The upper ESR film was then returned to the original position so that the maximum height of the ESR above the backplane was about 2.2 mm, forming a 2:1 expanding wedge from the LED location. The TLF measured in the configuration was 47.95 lumens, indicating that the engine was 96% efficient.

### Example 2

### Polarized Hemispheric Efficiency of Backlight System

A backlight system was constructed using a backlight frame made to be 2.5 mm high, 100 mm wide, 200 mm long, and having a wall thickness of 8 mm. The inside perimeter surface of the frame was covered with ESR. The frame was placed on the film-based light injectors disposed on the backplane in various configurations as described below. Each film-based light injector measured 29 mm in length, and was powered at 30 mA and 19.7 V. The front reflector consisted of a laminate including a beaded diffuser (Keiwa Opalus 702, available from Keiwa Inc., Osaka, Japan) adhered to an asymmetric reflecting film (ARF) (32% transmission in the machine direction (TMD) aligned polarization, available from 3M Company) adhered to a 0.005″ (0.2 mm) thick polycarbonate sheet. Each of the layers in the laminate was adhered using OPT-1 adhesive (available from 3M Company). An absorptive polarizer was placed over the plate, for measurement of polarized light as used in an LCD. TLF for each configuration was again measured in an Optronic integrating sphere.

First configuration: a single light injector was placed 4 mm from the 100 mm sidewall, with the exit aperture facing down the length of the backlight. The TLF measurement was 27.23 lumens, corresponding to a total polarized hemispheric system efficiency of 54.5% relative to the total light output from the LEDs. By comparison to the TLF of the LEDs with the wedge, the cavity efficiency was 56.8%.

Second configuration: two light injectors were placed in the cavity. The first light injector was again placed 4 mm from the 100 mm sidewall, with the exit aperture facing down the length of the backlight. The second light injector was placed parallel to the first light injector, separated by a 1 mm transport zone, with the exit aperture facing down the length of the backlight. Only the first light injector was powered. The TLF measurement for the system was 24.17 lumens, corresponding to a total polarized hemispheric system efficiency of 48.4% relative to the total light output from the LEDs. By comparison to the TLF of the LEDs with the wedge, the cavity efficiency was 50.4%.

Third configuration: two light injectors were placed in the cavity. The first light injector was again placed 4 mm from the 100 mm sidewall, with the exit aperture facing down the length of the backlight. The second light injector was placed parallel to the first light injector, separated by a 30 mm transport zone, with the exit aperture facing toward the first light injector. Only the first light injector was powered. The TLF measurement for the system was 22.48 lumens, corresponding to a total polarized hemispheric system efficiency of 45.0% relative to the total light output from the LEDs. By comparison to the TLF of the LEDs with the wedge, the cavity efficiency was 46.9%.

### Example 3

### Four Light Injector Backlight System Brightness Profile

A four light injector backlight system was constructed using the backlight system of Example 2 with 4 light injectors, to measure the brightness profile of a backlight in several configurations. Unless otherwise specified, each light injector had 3 subunits of LEDs; each subunit was operated at 10 mA, for a total of 30 mA for each light injector at 19.8 V. The first light injector was placed 4 mm from the 100 mm sidewall, with the exit aperture facing down the length of the backlight. The second light injector was placed parallel to the first light injector, separated by a 1 mm transport zone, with the exit aperture facing down the length of the backlight. The third light injector was placed parallel to the second light injector, separated by a 1 mm transport zone, with the exit aperture facing down the length of the backlight. The fourth light injector was placed parallel to the first light injector, 4 mm from the opposite 100 mm sidewall (i.e. at the other end of the cavity), with the exit aperture facing toward the first, second and third light injectors. The centerline brightness profile (i.e. the brightness measured along the 200 mm length in the center of the 100 mm width) of the four light injector backlight assembly was measured perpendicular to the front reflector, for conditions described below.

### Example 4

### Control Brightness Profile for a Four Light Injector Backlight System Using a Diffuser Sheet with No Front Reflector

The front reflector ARF laminate of the four light injector backlight system was removed from the backlight frame, and replaced with a bulk diffuser plate that had been removed from a Sony 23″ (58.4 cm) monitor. All four light injectors were turned on, and the centerline brightness profile was measured. All four injectors exhibited spikes of roughly double the brightness (e.g. 4941 nits) measured near the exit apertures, compared to the brightness (e.g. 2322 nits) of the plateau regions between them. The average brightness of the regions between the injectors and the sidewalls (between the first light injector and sidewall and the fourth light injector and the opposite sidewall) was approximately 100 nits.

### Example 5

### Brightness Profile for a Four Light Injector Backlight System—All Lights On

Each of the four light injectors in the four light injector backlight system with ARF laminate front reflector were turned on, and the centerline brightness was measured. The first through fourth light injectors were powered at 25 mA, 26 mA, 23 mA and 31 mA, respectively. The centerline brightness showed peaks and valleys that exhibited much less variation than the control in Example 4. Maximum brightness was 3745 nits and the average brightness in the “bright zone” (vicinity of first through third light injectors) was 3254 nits. A significant trough was seen between the third and fourth light injectors (that face each other), and the average brightness of the regions between the injectors and the sidewalls was approximately 400 nits.

### Example 6

### Brightness Profile for a Four Light Injector Backlight System—Zonal Control

Zonal control of the backlight was demonstrated by using the same conditions as Example 5, with the exception that the second light injector was turned off. The centerline maximum brightness was 3530 nits and the average brightness in the “bright zone” was 2362 nits. The average brightness of the regions between the injectors and the sidewalls was approximately 400 nits.

### Example 7

### Brightness Profile for a Four Light Injector Backlight System—High Brightness

The same conditions were used as in Example 4, with the exception that the power to each of the first through fourth light injectors was increased to 60 mA. The centerline brightness showed peaks and valleys that exhibited much less variation than the control in Example 4. Maximum brightness was 10225 nits and the average brightness in the “bright zone” was 7512 nits. A smaller trough was seen between the third and fourth light injectors (that face each other) than in Example 6. The average brightness of the regions between the injectors and the sidewalls was approximately 1200 nits.

### Example 8

### Brightness Profile for a Four Light Injector Backlight System—Uniformity Improvement

The same conditions were used as in Example 5, with the exception that only the first and second light injectors were turned on. The centerline brightness was measured in the vicinity of the first through third light injectors, and showed peaks and valleys that exhibited much less variation in this region than the control in Example 4. Maximum brightness was 3748 nits and the average brightness in the “bright zone” was 3405 nits. The average brightness of the regions between the injectors and the sidewalls was approximately 400 nits.

Uniformity was then improved by placing a sheet of polycarbonate Brightness Enhancement Film (PCBEF available from 3M Company) aligned to the pass axis of the ARF. The centerline brightness showed smaller peaks and valleys than without the PCBEF. The maximum brightness was 4173 nits and the average brightness in the “bright zone” was 3818 nits, representing an approximately 12% gain in brightness. The average brightness of the regions between the injectors and the sidewalls was approximately 400 nits.

The PCBEF film was then removed and aligned transverse to the pass axis of the ARF. The maximum brightness was 4870 nits and the average brightness in the “bright zone” was 4451 nits, representing an approximately 31% gain in brightness. The average brightness of the regions between the injectors and the sidewalls was approximately 400 nits.

### Example 9

### Brightness Profile for a Four Light Injector Backlight System—Zero Bezel

The same conditions were used as in Example 5, with the exception that only the first through third light injectors were turned on, and an additional reflective sidewall was placed between the third and fourth light injectors at separation of approximately one light injector width from the third light injector. In this manner, the exit aperture of the third light injector faced the additional reflective sidewall. The centerline brightness was measured in the vicinity of the first through third light injectors, and showed peaks and valleys that exhibited much less variation in this region than the control in Example 4. Maximum brightness was 3720 nits and the average brightness in the “bright zone” was 3260 nits. The average brightness in the region between the first injector and the sidewall was approximately 400 nits. The brightness measured nearest to the additional sidewall was 1800 nits, and demonstrated that the backlight could be operated without needing external injection or a bezel.

### Example 10

### Brightness Profile for a Four Light Injector Backlight System—Zoning by Control of Light Extraction Rate (Influence of R^{f}ₕₑₘᵢ)

The rate of light extraction was controlled by using different percent transmission front reflector films. The same conditions were used as in Example 5, with the exception that only the fourth light injector was turned on, and the ARF portion of the front reflector laminate was changed. FIG. 9 shows the centerline brightness in the vicinity of the fourth light injector for three different films: ARF with 11% TMD (small R^{f}ₕₑₘᵢ), ARF with 32% TMD (mid R^{f}ₕₑₘᵢ), and Advanced Polarizer Film (APF, available from 3M Company) with 98% TMD (high R^{f}ₕₑₘᵢ). The exit aperture for the fourth light injector is positioned at the 50 mm position in FIG. 9. As R^{f}ₕₑₘᵢ increases, the variation in brightness decreases from the exit aperture, with a concomitant increase in the spreading of light laterally from the centerline.

### Example 11

### Modeling Simulation of Internal-Injection Backlights

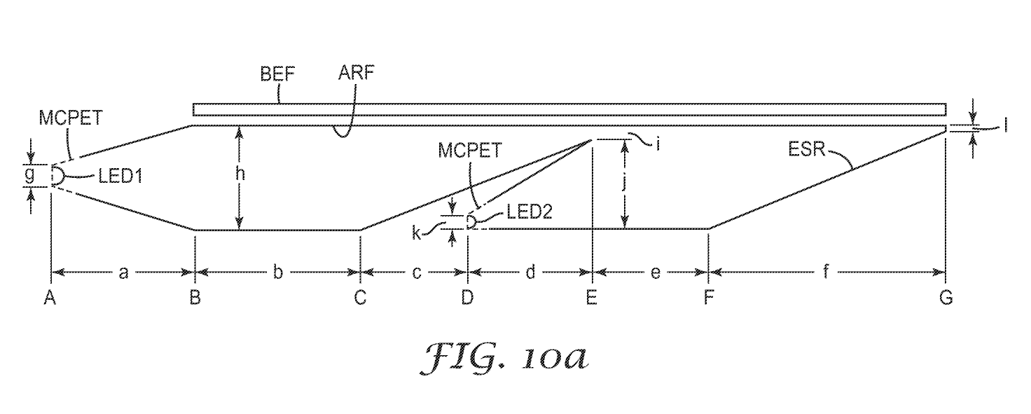

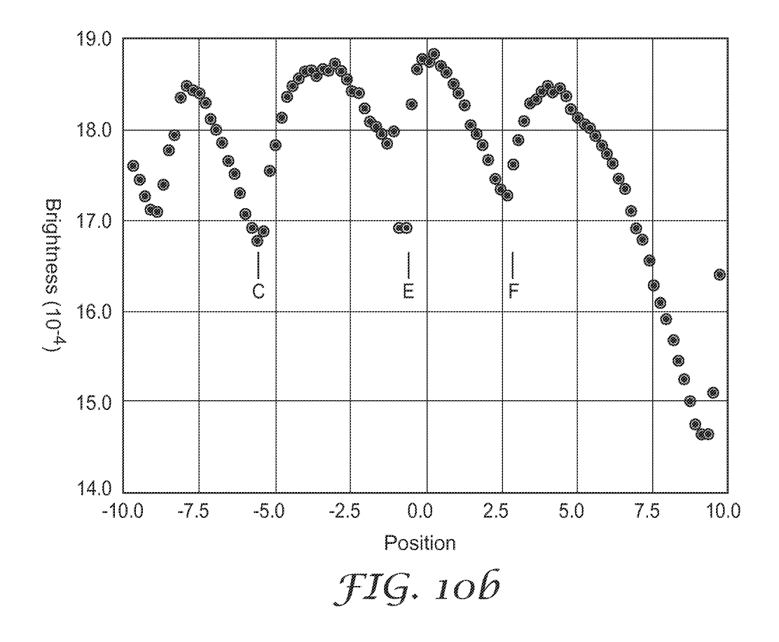

A 40-inch diagonal, 16:9 aspect ratio, internal-injection backlight was modeled using the layout shown in FIG. 10a. The dimensions (in mm) used in the model were: a=38.1; b=112.1; c=74.0; d=38.1; e=95.8; f=178.1; g=3.8; h=12.9; i=3.8; j=9.1; k=2.6; l=3.8 mm. The 12.9 mm deep frame had a front reflector consisting of an ARF (32% transmission in the machine direction (TMD), such as available from 3M Company) adhered to a beaded diffuser (such as Keiwa Opalus 702, available from Keiwa Inc., Osaka, Japan) over the frame, an airgap, and a grooves-vertical BEF prismatic film over the front reflector. The remaining interior surfaces of the cavity were lined with specularly-reflecting high-efficiency mirror film (such as ESR, 99.5% reflectivity, available from 3M Company).

An external, symmetric, 3.5:1, 38.1-mm wedge filled an edge (“B”) of the cavity, and was illuminated by LED1 (such as 39 LumiLeds Luxeon Rebel LEDs, available from Philips Lumileds, San Jose, Calif.) on the back surface of the wedge near the distal (shallow) end. LED1 consisted of three groups of WWWBGRGRGBWWW devices at a uniform 23-mm pitch. An internal, asymmetric, 3.5:1, 38.1-mm baffle (“C” to “E”) filled a substantial portion of the cavity depth, illuminated by LED2 (identical to LED1) on the back surface near the distal end. The proximal aperture of the internal wedge was 9.1 mm high, and located at a position (“E”) near the midpoint of the backlight as shown in FIG. 10a. A sloped end reflector (“F” to “G”) was positioned to reflect light emitted from LED2 toward the ARF at the front surface of the backlight.

The remaining interior surfaces were lined with ESR except in the immediate vicinity of the LEDs near their distal ends, as shown in FIG. 10a, where they were lined with a high-efficiency diffuse reflector (such as MCPET, 98.5% reflectivity, available from 3M Company) to reduce the sensitivity of optical performance to precision alignment of the LEDs. The two LED arrays, LED1 and LED2, were assumed to emit identical fluxes.

FIG. 10b shows a plot of the predicted brightness when viewed from a position 72 inches (183 cm) from the center of the front reflector, averaged over horizontal positions parallel to the illuminated edge of the backlight, as a function of position (in inches) from the vertical centerline of the front reflector. The brightness values shown are in units of Lumens/inch/steradian, and correspond to a total emitted source flux of one Lumen. The positions “C”, “E” and “F” correspond to the positions shown in FIG. 10a. The level of non-uniformity is generally acceptable for many edge-lit backlights.

The total source flux desired to achieve an average normal-view brightness equal to 5000 nits (measured through an absorbing polarizer, i.e. the LCD-useable emission) is 6850 Lumens. The desired 6850 Lumens were achieved using the 78 LEDs (LED1 and LED2) at an operating current corresponding to power consumption just over 2.5 Watts per device. The corresponding thermal loads were approximately 1.2 W/cm along each of the two source arrays, near the anticipated upper limits of passive cooling. The total power consumption was 208 W.

The embodiments described above can be applied anywhere that thin, optically transmissive structures are used, including displays such as TV, notebook and monitors, and used for advertising, information display or lighting. The present disclosure is also applicable to electronic devices including laptop computers and handheld devices such as Personal Data Assistants (PDAs), personal gaming devices, cellphones, personal media players, handheld computers and the like, which incorporate optical displays. The illumination devices of the present disclosure have application in many other areas. For example, zoned backlit LCD systems where different regions of the backlight are controlled differently depending on display content, luminaires, task lights, light sources, signs and point of purchase displays can be made using this invention.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. (canceled)

2. An illumination device, comprising:
a partially transmissive front reflector having an output area;
a back reflector facing the partially transmissive front reflector, forming a hollow cavity between the partially transmissive front reflector and the back reflector;
a plurality of light injectors disposed in an array in the hollow cavity, each of the plurality of light injectors comprising:
a first reflective surface projecting from the back reflector and facing the partially transmissive front reflector;
a second reflective surface contiguous with the first reflective surface and facing the back reflector; and
a light source operable to inject light between the second reflective surface and the back reflector, so that injected light is partially collimated in a first direction within 30 degrees of a transverse plane parallel to the partially transmissive front reflector;
a transport region disposed between adjacent light injectors; and
a semi-specular element disposed in the hollow cavity,
wherein at least a portion of injected light from a first light injector reflects from the first reflective surface of an adjacent light injector, and is directed toward the partially transmissive front reflector.

3-4. (canceled)

5. The illumination device of claim 2, wherein the semi-specular element is disposed adjacent the partially transmissive front reflector.

6. The illumination device of claim 2, wherein the partially transmissive front reflector reflects oblique-angle light more than normally incident light.

7. The illumination device of claim 2, wherein the partially transmissive front reflector comprises an on-axis average reflectivity of at least 90% for visible light polarized in a first plane, and an on-axis average reflectivity of at least 25% but less than 90% for visible light polarized in a second plane perpendicular to the first plane.

8. The illumination device of claim 2, wherein the back reflector comprises an on-axis average reflectivity of at least 95% for visible light of any polarization.

9. The illumination device of claim 2, wherein at least one of the first reflective surface and second reflective surface comprises an on-axis average reflectivity of at least 95% for visible light of any polarization.

10. The illumination device of claim 2, wherein at least one light source comprises an LED.

11. The illumination device of 10, wherein the LED emits light within an angular spread of less than 360 degrees around an axis perpendicular to the partially transmissive front reflector.

12-15. (canceled)

16. An illumination device, comprising:
a partially transmissive front reflector having an output area;
a back reflector facing the partially transmissive front reflector, forming a hollow cavity between the partially transmissive front reflector and the back reflector;
a first light source operable to inject a first collimated light beam into the hollow cavity;
a light injector formed by a baffle projecting into the hollow cavity from the back reflector, the baffle comprising a first reflective surface positioned to reflect a portion of the first collimated light beam toward the partially transmissive front reflector;
a second light source disposed within the light injector, operable to inject a second collimated light beam into the hollow cavity;
a transport region between the first light source and the light injector; and
a semi-specular element disposed in the hollow cavity,
wherein at least a portion of injected light from the first light source reflects from the first reflective surface of the baffle, and is directed toward the partially transmissive front reflector.

17. The illumination device of claim 16, wherein the first and second collimated light beams comprise collimation in a direction substantially within 30 degrees of a transverse plane parallel to the partially transmissive front reflector.

18. The illumination device of claim 16, wherein the first reflective surface and the back reflector form a continuous surface.

19. The illumination device of claim 16, wherein the baffle further comprises a second reflective surface opposite the first reflective surface.

20. The illumination device of claim 19, wherein the first reflective surface and second reflective surface are co-planar.

21. The illumination device of claim 16, wherein the semi-specular element is disposed adjacent the partially transmissive front reflector.

22. (canceled)

23. The illumination device of claim 16, wherein the partially transmissive front reflector comprises an on-axis average reflectivity of at least 90% for visible light polarized in a first plane, and an on-axis average reflectivity of at least 25% but less than 90% for visible light polarized in a second plane perpendicular to the first plane.

24. The illumination device of claim 16, wherein the back reflector comprises an on-axis average reflectivity of at least 95% for visible light of any polarization.

25. (canceled)

26. The illumination device of claim 16, wherein at least one light source comprises an LED.

27. The illumination device of claim 26, wherein the LED emits light within an angular spread of less than 360 degrees around an axis perpendicular to the partially transmissive front reflector.

28-36. (canceled)

37. A backlight comprising the illumination device of claim 2 or claim 16.

38. A liquid crystal display comprising the backlight of claim 37, wherein the liquid crystal display is disposed proximate the output area.

39. (canceled)
